(19) United States
(12) Patent Application Publication
(10) Pub. No.: US 2006/0220968 A1
(43) Pub. Date: Oct. 5, 2006

(54) Wireless signal transmission restriction device

(76) Inventor: William Charles Arabio, Ronkonkoma, NY (US)

Correspondence Address: William Charles Arabio, PO Box 1109, Ronkonkoma, NY, 11779, US

(21) Appl. No.: 11/299,556

(22) Filed: Dec. 13, 2005

Related U.S. Application Data
(60) Provisional application No. 60/666,608, filed on Mar. 31, 2005.

(51) Int. Cl. H01Q 1/24

(52) U.S. Cl. 343/702; 343/872; 343/841

(57) ABSTRACT

Disclosed herein is a wireless signal transmission restriction device for directing or limiting signal transmission range of signal transmission devices. In one embodiment, the wireless signal transmission restriction device comprises a hollow elongated enclosure having a closed first end and an open second end configuring an internal space therein. The hollow elongated enclosure is capable of sliding to a position on an antenna of the signal transmission device to cover a portion of the antenna. The device can also be opened to various angles thereby controlling the direction of the transmissions. The wireless signal transmission restriction device further comprises a fastening mechanism for securing the hollow elongated enclosure to the antenna at the position, thereby exposing a remaining portion of the antenna for limited signal transmission.

### CROSS-REFERENCE TO RELATED APPLICATIONS:

The present application claims priority to U.S. Provisional Application, Ser. No.______ 60/666,608______, filed on Mar. 31, 2005, which is incorporated herein by reference.

### FIELD OF THE INVENTION

The present invention relates generally to signal restriction devices, and, more particularly to, wireless signal transmission restriction devices capable of limiting signal transmission range of communication devices.

### BACKGROUND OF THE INVENTION

No doubt that wireless communication has revolutionized the telecommunication sector, but it has brought alongside the risks of data theft and hacking. Communication devices use the telecommunication antennas for transmitting data across other communication units wirelessly. The extent of data exchange or more particularly the range of transmission depends upon the strength of signal transmission by the antenna of the communication devices. Further, it also depends upon whether the signals are interrupted during transmission across to the other communication device. Depending upon the need of data transmission across to the other communication device the strength of the signals can be regulated. This becomes a specific configuration for each of the communication device. And at the same time there is always a threat of identity theft, internet privacy issues and protecting the information on ones computer systems. The techniques of data encryption are little too complex for a common man and at the same time expensive too. There is no device whatsoever available that is retrofittable to any type of protruding antennas of communication devices that enclose or direct the antennas and restrict or confine the signal transmission in the desired direction.

Also, several attempts have been made in areas for providing antenna covers for mobile communication devices however, have fallen short of meeting the above desired requirements.

U.S. Pat. No. 6,388,614 discloses an antenna aperture cover that is placed over an opening of a feed horn to block some of the radiation coming into the feed horn, such that, the amount of power coming into the feed horn can be controllably varied and measured to determine the error angle and direction through which the satellite dish needs to be turned to achieve optimum reception from a geo-synchronous satellite. The patent does not provide a retrofittable signal restriction device capable of limiting the signal transmission range.

U.S. Pat. No. 6,043,793 discloses a GPS (Global Positioning System) antenna cover comprising a box-like cover body formed by a top wall and four side walls. The cover body has an opened bottom, a GPS antenna receiving chamber defined by four inner walls extending perpendicularly from an inner face of the top wall towards the bottom, and a first holding member formed on and projecting inwardly from inner faces of the inner side walls for holding a GPS antenna unit from the side of the bottom. The GPS antenna unit is inserted into the antenna receiving chamber through the bottom. The antenna receiving chamber includes a second holding member formed on and project inwardly from the inner face of the top wall for abutting against an upper face of the GPS antenna unit and urging the GPS antenna unit from the side of the top wall. The patent does not provide any arrangement for desirably limiting/restricting the signal transmission in GPS antenna and related devices.

None of the prior art particularly discuss any external device to limit/restrict the signal transmission range of wireless communication devices. Accordingly, there remains a need for a wireless signal transmission restriction device that enhances protection of data stored on computer systems during wireless data transmission; restricts outside monitoring of emails, websites visited and internet transaction performed by any user wirelessly; discourages hackers with weak or no wireless signals and at the same time is inexpensive, and enables easy installation.

### SUMMARY OF THE INVENTION:

In view of the foregoing disadvantages inherent in the prior arts, the general purpose of the present invention is to provide a signal restriction device, to include all the advantages of the prior arts, and to overcome the above-mentioned disadvantages/drawbacks inherent therein.

The present invention provides a wireless signal transmission restriction device configured to cover a portion of an antenna of a signal transmission device, thereby exposing only a remaining portion of the antenna for limited signal transmission and/or controlling the direction of the transmission.

In one aspect, the present invention provides a wireless signal transmission restriction device comprising a hollow elongated enclosure having a closed first end and an open second end configuring an internal space therein. The hollow elongated enclosure is capable of sliding to a position on an antenna of the signal transmission device, to cover a portion of the antenna. The wireless signal transmission restriction device further comprises a fastening mechanism for securing said hollow elongated enclosure to the antenna at the position, thereby exposing a remaining portion of the antenna for limited or directed signal transmission.

In another aspect, the present invention provides a wireless signal transmission restriction device comprising an elongated concave first half enclosure coupled to an elongated concave second half enclosure using a clamping mechanism, thereby forming a hollow elongated enclosure with an internal space, the hollow elongated enclosure is capable of sliding to a position on an antenna of the signal transmission device, to cover a portion of the antenna. The wireless signal transmission restriction device further comprises a fastening mechanism for securing said hollow elongated enclosure to an antenna at the position, thereby exposing a remaining portion of the antenna for limited signal transmission.

In yet another aspect, the present invention provides a method for limiting signal transmission range of a wireless signal transmission device. The method comprises configuring a wireless signal transmission restriction device having a hollow elongated enclosure with a closed first end and an open second end forming an internal space therein, the wireless signal transmission restriction device further having a fastening mechanism; sliding the hollow elongated enclosure of the wireless signal transmission restriction device from the open second end to a position on the antenna to cover a portion of the antenna; and securing the wireless signal transmission restriction device to the antenna at the position, using the fastening mechanism thereby exposing a remaining portion of the antenna for limited signal transmission.

These together with other aspects of the present invention, along with the various features of novelty that characterize the invention, are pointed out with particularity in the claims annexed hereto and forming a part of this disclosure. For a better understanding of the invention, its operating advantages and the specific objects attained by its uses, reference should be made to the accompanying drawings and descriptive matter in which there are illustrated exemplary embodiments of the invention.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and wherein:

FIG. 1 illustrates a side view of a wireless signal transmission restriction device 100, according to an exemplary embodiment of the present invention;

FIG. 2 is a bottom view of the wireless signal transmission restriction device 100, according to an exemplary embodiment of the present invention;

FIG. 3 illustrates a side view of the wireless signal transmission restriction device 100, with a ring 24, according to another exemplary embodiment of the present invention;

FIG. 4 is a bottom view of the wireless signal transmission restriction device 100 illustrating the ring 24, according to an exemplary embodiment of the present invention;

FIG. 5 illustrates a side view of a wireless signal transmission restriction device 200, according to an exemplary embodiment of the present invention;

FIG. 6 illustrates an application of the wireless signal transmission restriction device 200 with an antenna 300 of a communication device 400, according to an exemplary embodiment of the present invention; and

FIG. 7 shows the partially opened wireless signal transmission restriction device 200, illustrating the application, according to another exemplary embodiment of the present invention.

Like reference numerals refer to like parts throughout several views of the drawings of the present invention.

### DETAILED DESCRIPTION OF THE INVENTION

The exemplary embodiments described herein detail for illustrative purposes are subject to many variations in structure and design. It should be emphasized, however that the present invention is not limited to a particular signal restriction device as shown and described. It is understood that various omissions, substitutions of equivalents are contemplated as circumstances may suggest or render expedient, but is intended to cover the application or implementation without departing from the spirit or scope of the claims of the present invention.

The present invention provides a signal restriction device, and more particularly, a wireless signal transmission restriction device configured to direct or limit signal transmission of communication devices, for example signal transmission devices, such as, wireless network, (Wi-Fi) transmitters, and the like. The wireless signal transmission restriction device of the present invention has a size, shape and configuration, such that, the wireless signal transmission restriction device can at least partially enclose an antenna of a communication device, thereby controlling and limiting the signal transmission range of the signal transmission devices. In an exemplary embodiment, the wireless signal transmission restriction device of the present invention is made of an aluminum compound and configured to be placed anywhere on an antenna of a communication device.

The wireless signal transmission restriction device of the present invention limits about 20 to 80 percent of the signal transmission (i.e., output signals), thereby enhancing protection of data stored on computer systems during wireless data transmission; restricting outside monitoring of emails, websites visited and internet transactions performed by any user wirelessly; and greatly reducing hacker's chance of getting into the privacy of computer systems in wireless network communications.

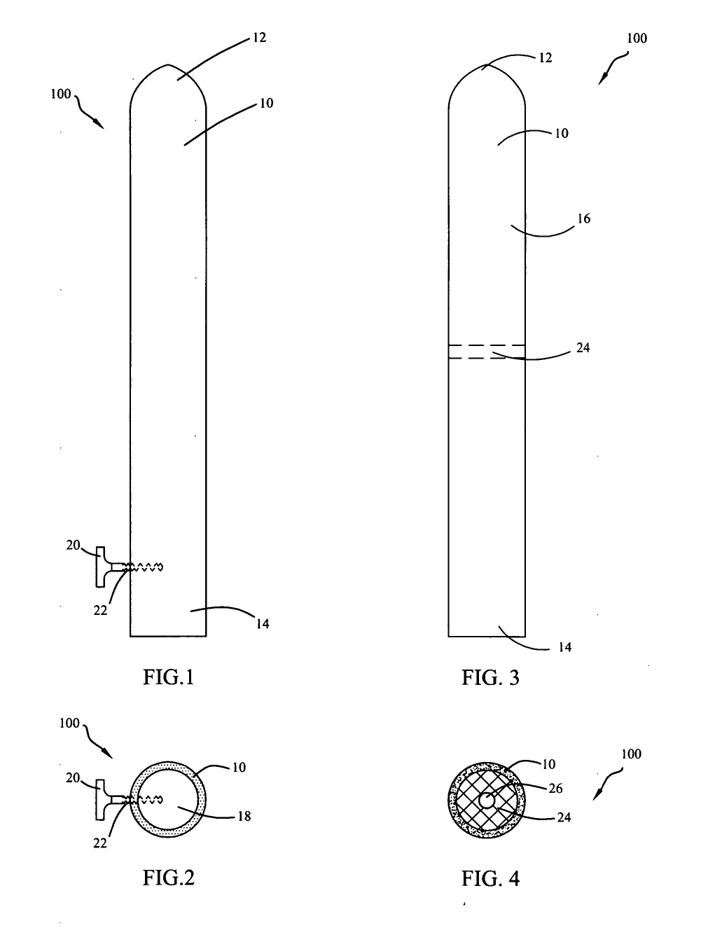

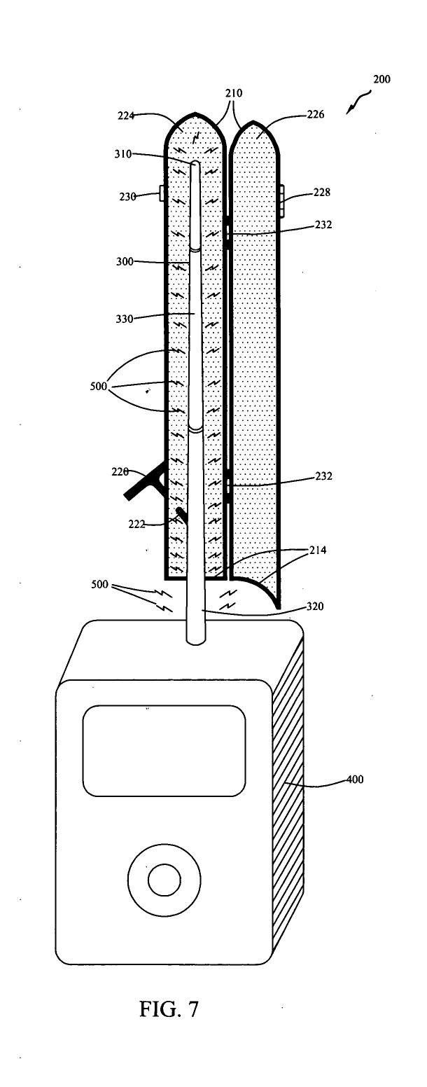

Referring to FIGS. 1-4, in one embodiment, a wireless signal transmission restriction device 100 is hollow elongated in configuration forming an enclosure 10, capable of sliding to a position on an antenna of a signal transmission device, to cover a portion of the antenna. The antenna may be a standard antenna protruding from body of the signal transmission device for wirelessly transmitting signals across to other signal transmission devices. For example, an antenna 300 of a signal transmission device 400, as shown in FIGS. 6 and 7. The enclosure 10 of the wireless signal transmission restriction device 100 has a closed first end 12, an open second end 14 and a body 16. The hollow elongated enclosure 10 forms an internal space 18 therein (See FIG. 2).

The wireless signal transmission restriction device 100 further has fastening mechanism for fastening the wireless signal transmission restriction device 100 to the antenna of the signal transmission device. Suitable fastening mechanism includes, but is not limited to, a set screw 20 with a plurality of threads 22. Preferably, the set screw 20 is configured towards the open second end 14 of the hollow elongated enclosure 10. The set screw 20 can be rotated clockwise, enabling the screw 20 to protrude inside the internal space 18, and rotated anticlockwise for pulling the set screw 20 back to its original position. Further, an inside of the enclosure body 16 forming the internal space 18 of the wireless signal transmission restriction device 100 is coated with a soft thin inner lining for preventing any damage to the antenna during operation. The wireless signal transmission restriction device 100 is secured to the antenna with the set screw 20, thereby exposing just enough of the antenna to provide signals that can be confined to a much smaller area. The ability to adjust the length of the exposing antenna by the set screw 20, for the purposes of enabling the required signal strength, qualifies for the retrofittability of the application of wireless signal transmission restriction device 100 to a variety of wireless signal transmission devices with protruding antenna.

In an additional embodiment, the fastening mechanism may further include an elastic ring 24 configured within the internal space 18 of the hollow elongated enclosure 10, as shown in FIG. 3 and FIG. 4. The elastic ring 24 has a central hole 26. The central hole 26 is capable of expanding and contracting due to the elastic properties of the elastic ring 24. The elastic ring 24 within the internal space 18 may be used independently or in combination with the set screw 20 for fastening the wireless signal transmission restriction device 100 to the antenna of the signal transmission device. The elastic ring 24 may be placed anywhere within the internal space 18 between the closed first end 12 and the open second end 14 to securely engage the antenna through the central hole 26. For signal transmission devices with small protruding antennas, the elastic ring 24 is configured towards the open second end 14 of the hollow elongated enclosure 10, such that, the antenna body is sufficiently engaged through the central hole 26.

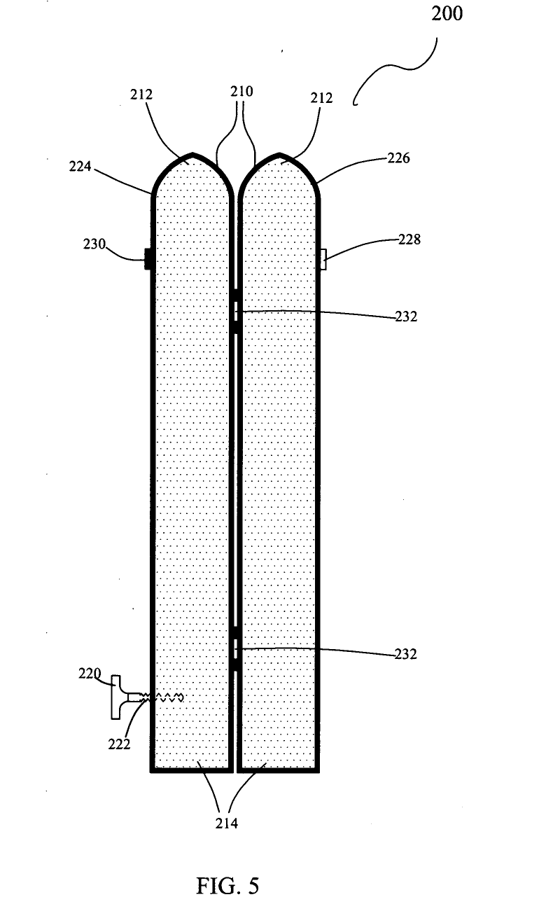

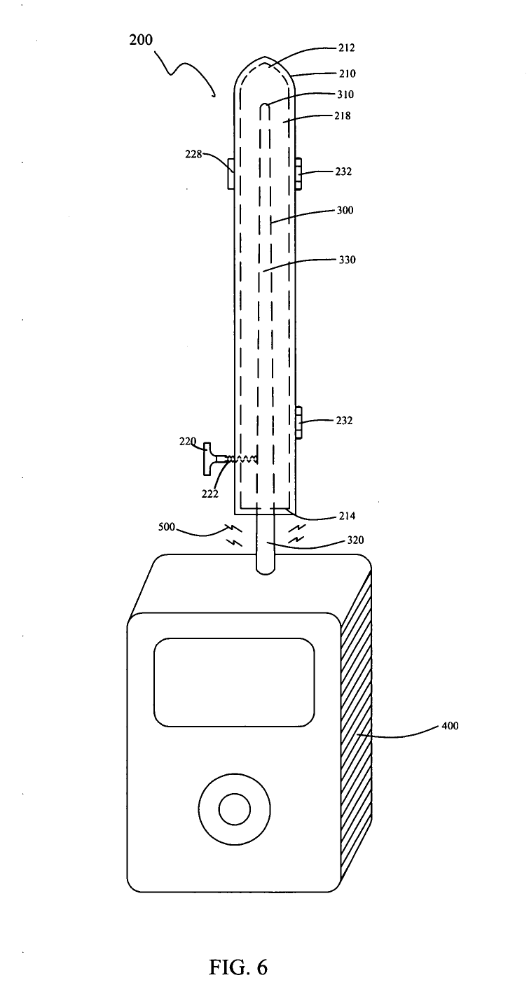

Referring to FIG. 5, in another embodiment, a wireless signal transmission restriction device 200 comprises two elongated concave symmetrical halves: a first half enclosure 224 and a second half enclosure 226. The first half enclosure 224 is coupled to the second half enclosure 226 using a clamping mechanism (for example, clamps 232), thereby enabling the closure of the second half enclosure 226 against the first half enclosure 224 forming a hollow elongated enclosure 210 with a closed first end 212 and an open second end 214. Further, the clamps 232 have arrangement for automatically locking at angular openings of 45°, 90°, 135°, and 180°, and at any other desired angular opening to control the direction of the transmissions. A fastening latch 228 may be configured on the body of the second half enclosure 226 with a holder 230 for receiving the fastening latch 228. The positioning of the fastening latch 228 and the receiving holder 230 may be interchangeably configured on any of the first half enclosure 224 and the second half enclosure 226. In one embodiment, upon closing the second half enclosure 226 against the first half enclosure 224, the fastening latch 228 is used for fastening the second half enclosure 226 with the first half enclosure 224, thereby configuring a complete hollow elongated enclosure 210. The wireless signal transmission restriction device 200 further has a fastening mechanism, including, but not limited to, a set screw 220 with a plurality of threads 222, for fastening the wireless signal transmission restriction device 200 to the antenna 300 of signal transmission device 400.

FIG. 6 illustrates the operation of the wireless signal transmission restriction device 200, according to an embodiment of the present invention. It is to be noted that the application of wireless signal transmission restriction device, as shown in FIG. 6, is for purposes of illustration only and the same should not be considered as restricting the scope of the application of the present invention. The wireless signal transmission restriction device 100, of the present invention, can also be used for such application with same effectiveness. The hollow elongated enclosure 210 is configured by closing the first half enclosure 224 and the second half enclosure 226, using the fastening latch 228 and the holder 230, thereby forming the wireless signal transmission restriction device 200. The wireless signal transmission restriction device 200 is slid over the antenna 300 of the signal transmission device 400, from the open second end 214 of the hollow elongated enclosure 210. The wireless signal transmission restriction device 200 is secured to the antenna 300 with the set screw 220, thereby exposing just enough of the antenna 300 to provide signals that can be confined to a much smaller area. The signals 500 are transmitted only from the lower end 320 of the antenna 300 and the signals transmitted from the upper end 310 and from the body 330 of the antenna 300 are restricted. The ability to adjust the length of the exposing antenna 300 by the set screw 220 for the purpose of enabling the required signal strength qualifies for the retrofittability of the application of wireless signal transmission restriction device 200 to a variety of signal transmission devices with protruding antenna.

FIG. 7 further shows a partially opened wireless signal transmission restriction device 200, illustrating the operation thereof. For illustrative purposes, the wireless signal transmission restriction device 200 is shown open at an angle of 135°. Depending upon the need of the signal strength the first half enclosure 224 and the second half enclosure 226 may be opened using the clamps 232 to the desired angle. FIG.7 illustrates that the wireless signal transmission restriction device 200 is secured to the antenna 300 using the fastening mechanism, for example the set screw 220 that is screwed to contact the antenna body 330. The opening of the first half enclosure 224 and the second half enclosure 226 in such an angular position enables transmission of signals 500 from the upper end 310, the lower end 320 and the body 330 of the antenna 300. However, the signals are limited to be transmitted from a side, where the first half enclosure 224 and the second half enclosure 226 is covering the antenna 300, thereby allowing signal transmission only from the open side of the wireless signal transmission restriction device 200.

Although the wireless signal transmission restriction device 100, 200 of the present invention has a hollow elongated configuration, it is to be noted that, wireless signal transmission restriction device of the present invention may be simply in the form of a metal sheet that wraps around an antenna of a signal transmission device for limiting signal transmission range of the signal transmission device.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is understood that various omissions, substitutions of equivalents are contemplated as circumstance may suggest or render expedient, but is intended to cover the application or implementation without departing from the spirit or scope of the claims of the present invention.

What is claimed is:

1. A wireless signal transmission restriction device for directing or limiting signal transmission range of a signal transmission device, comprising:
a hollow elongated enclosure having a closed first end and an open second end configuring an internal space therein, said hollow elongated enclosure capable of sliding to a position on an antenna of the signal transmission device to cover a portion of the antenna; and
a fastening mechanism for securing said hollow elongated enclosure to the antenna at said position, thereby exposing a remaining portion of the antenna for limited signal transmission.

2. The wireless signal transmission restriction device as claimed in claim 1, wherein said wireless signal transmission restriction device is capable of being secured at a plurality of positions on the antenna, thereby restricting about 20 to 80 percent of the signal transmission from the signal transmission device.

3. The wireless signal transmission restriction device as claimed in claim 1, wherein said fastening mechanism comprises a set screw with threads.

4. The wireless signal transmission restriction device as claimed in claim 3, wherein said set screw may be rotated clockwise for securing said wireless signal transmission restriction device to the antenna of the signal transmission device and rotated anticlockwise for releasing the wireless signal transmission restriction device from said antenna of the signal transmission device.

5. The wireless signal transmission restriction device as claimed in claim 1, wherein said fastening mechanism comprises an elastic ring secured within said internal space, said elastic ring having a central hole for enabling passage of the antenna of the signal transmission device.

6. The wireless signal transmission restriction device as claimed in claim 5, wherein said elastic ring may be configured anywhere within said internal space between said closed first end and said open second end.

7. The wireless signal transmission restriction device as claimed in claim 6, wherein said elastic ring is capable of expanding and receiving the antenna when received within said central hole and secures said wireless signal transmission restriction device against the antenna of the signal transmission device.

8. The wireless signal transmission restriction device as claimed in claim 1, wherein an inside of said hollow elongated enclosure is coated with a soft thin inner lining for preventing any damage to the antenna.

9. A wireless signal transmission restriction device for directing or limiting signal transmission range of signal transmission devices, the wireless signal transmission restriction device, comprising:
an elongated concave first half enclosure coupled to an elongated concave second half enclosure using a clamping mechanism, thereby forming a hollow elongated enclosure with an internal space, said hollow elongated enclosure capable of sliding to a position on an antenna of the signal transmission device to cover a portion of the antenna;
a fastening mechanism for securing said hollow elongated enclosure to the antenna at said position, thereby exposing a remaining portion of the antenna for signal transmission.

10. The wireless signal transmission restriction device as claimed in claim 9, wherein said clamping mechanism comprises clamps, capable of automatically locking at predefined angular openings.

11. The wireless signal transmission restriction device as claimed in claim 9, wherein said fastening mechanism comprises a set screw with threads.

12. The wireless signal transmission restriction device as claimed in claim 11, wherein said set screw may be rotated clockwise for securing said wireless signal transmission restriction device to an antenna of the signal transmission devices and rotated anticlockwise for releasing the wireless signal transmission restriction device from the antenna of the signal transmission devices.

13. The wireless signal transmission restriction device as claimed in claim 9, wherein an inside of said hollow elongated enclosure is coated with a soft thin inner lining for preventing any damage to the antenna.

14. The wireless signal transmission restriction device as claimed in claim 9, wherein said wireless signal transmission restriction device is capable of being secured at a plurality of positions on the antenna, thereby restricting about 20 to 80 percent of the signal transmission from the signal transmission device.

15. A method for limiting signal transmission range of wireless signal transmission device, the method comprises:
configuring a wireless signal transmission restriction device having a hollow elongated enclosure with a closed first end and an open second end forming an internal space therein, said wireless signal transmission restriction device further having a fastening mechanism;
sliding said hollow elongated enclosure of said wireless signal transmission restriction device from said open second end to a position on an antenna to cover a portion of the antenna; and
securing said wireless signal transmission restriction device to the antenna at said position on using said fastening mechanism, thereby exposing a remaining portion of the antenna for limited signal or directional transmission.

16. The method as claimed in claim 15, wherein said wireless signal transmission restriction device is capable of being secured at a plurality of positions on the antenna, thereby restricting about 20 to 80 percent of the signal transmission from the signal transmission device.

17. The method as claimed in claim 15, wherein said fastening mechanism comprises a set screw with threads configured to secure said wireless signal transmission restriction device to the antenna of the wireless signal transmission device.
